(19) United States
(12) Patent Application Publication
(10) Pub. No.: US 2014/0265590 A1
(43) Pub. Date: Sep. 18, 2014

(54) PRE-REGULATOR AND PRE-REGULATION METHODS FOR PHOTOVIOLTAIC INVERTERS

(71) Applicant: Advanced Energy Industries, Inc., Fort Collins, CO (US)

(72) Inventor: Eric Seymour, Fort Collins, CO (US)

(73) Assignee: Advanced Energy Industries, Inc., Fort Collins, CO (US)

(21) Appl. No.: 14/214,859

(22) Filed: Mar. 15, 2014

Related U.S. Application Data
(60) Provisional application No. 61/798,725, filed on Mar. 15, 2013.

(51) Int. Cl. H02M 3/156

(52) U.S. Cl. CPC H02M 3/156
USPC 307/63

(57) ABSTRACT

Methods and devices for pre-regulating power are disclosed herein. The method may include sectioning at least a portion of a photovoltaic array into two array subsections and applying power from the two array subsections to a power conversion component. A voltage that is applied by each of the two subsections varies with environmental conditions affecting the two array sections. A connection between the two array subsections is alternated from a series arrangement and a parallel arrangement to regulate a voltage level of the power that is applied by both of the two subsections to the power conversion component.

### CLAIM OF PRIORITY UNDER 35 U.S.C. §119

The present Application for Patent claims priority to Provisional Application No. 61/798,725 entitled “PRE-REGULATOR AND PRE-REGULATION METHODS FOR PHOTOVOLTAIC INVERTERS” filed Mar. 15, 2013, and assigned to the assignee hereof and hereby expressly incorporated by reference herein.

### BACKGROUND

1. Field

The present invention relates generally to photovoltaic systems, and more specifically to pre-regulation of power that is applied to inverters

2. Background

Increasingly, photovoltaic electricity generation systems are contributing to the supply of power in existing electrical distribution systems. In a typical photovoltaic system, photovoltaic arrays convert sunlight to direct current, and the direct current is converted to alternating current by an inverter.

Inverters, however, have difficulty traversing the broad range of direct current voltages that photovoltaic arrays are prone to generating. For example, variations in the intensity of sunlight that reaches the photovoltaic arrays and the outside temperature can dramatically affect the voltage level that is applied by photovoltaic arrays. And these variations in voltage levels adversely affect the reliability and performance of inverters.

As a consequence, pre-regulators have been developed and deployed to receive the voltage that is applied from photovoltaic arrays and regulate (e.g., by bucking or boosting) the voltage of the photovoltaic arrays to render a more consistent voltage at the inverter. But these pre-regulators are lossy and expensive, and as a consequence, as photovoltaic inverters continue to be operated at higher power levels, these existing pre-regulators will become increasingly unsatisfactory.

### SUMMARY

One aspect of the present invention includes a method for regulating an application of power from a photovoltaic array. The method may include sectioning at least a portion of the photovoltaic array into two array subsections and applying power from the two array subsections to a power conversion component. A voltage that is applied by each of the two subsections varies with environmental conditions affecting the two array sections. A connection between the two array subsections is alternated from a series arrangement and a parallel arrangement to regulate a voltage level of the power that is applied by both of the two subsections to the power conversion component.

Another aspect may be characterized as a pre-regulator for regulating an application of variable DC voltage. The pre-regulator may include a first pair of inputs to couple to a first subsection of the photovoltaic array, a second pair of inputs to couple to a second subsection of the photovoltaic array, and an output pair of terminals to couple to a power conversion device. The pre-regulator also includes a switching component that switches the first and second pair of inputs between a series arrangement and a parallel arrangement to regulate a voltage level of the power that is applied by both of the two subsections to the output pair of terminals.

Yet another aspect may be characterized as a system for inverting power from a photovoltaic array from DC power to AC power. The system may include an inverter that converts DC power to AC power and a pre-regulator that switches two subsections of a photovoltaic array between a series arrangement and a parallel arrangement to regulate a voltage level of the power that is applied by the array to the inverter.

### BRIEF DESCRIPTION OF THE DRAWINGS

FIG. 1 is a diagram depicting of an exemplary embodiment photovoltaic energy system;

FIG. 2 is a block diagram depicting an exemplary embodiment of the pre-regulator described with reference to FIG. 1;

FIG. 3 is a block diagram depicting another embodiment of the pre-regulator described with reference to FIG. 1;

FIG. 4 is a flowchart depicting a method that may be traversed in connection with the embodiments depicted in FIGS. 1-3;

FIG. 5 is a graphical depiction of exemplary voltages of the array subsections of FIG. 1 operating in an open-circuit mode of operation;

FIG. 6 is a graphical depiction of exemplary voltages of the array subsections of FIG. 1 when operating in a low-power mode of operation;

FIG. 7 is a graphical depiction of exemplary voltages of the array subsections of FIG. 1 when operating in a high-power mode of operation.

FIG. 8 is a block diagram depicting an exemplary embodiment of a control component; and

FIG. 9 is a block diagram depicting exemplary components that may be utilized to realize the control component depicted in FIG. 8.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Referring first to FIG. 1, it is a block diagram depicting an exemplary system for converting DC power from a photovoltaic array to AC power or to DC power. As shown, the system includes a power conversion component 102 (e.g., a DC-to-DC converter or an inverter) that converts DC power to either DC power or AC power and a pre-regulator 104 that switches a first array subsection 106 and a second array subsection 108 (also referred to herein as array 1 and array 2) between a series arrangement and a parallel arrangement to regulate a voltage level of the power that is applied by an array 110 to the power conversion component 102. As depicted, each of the array subsections 106 and 108 may include a plurality of strings (S) that are arranged in parallel within each array subsection 106 and 108, and each string (S) may include a plurality of photovoltaic panels (e.g., 24V or 100V panels) that are arranged in series within a string.

In general, the photovoltaic array 110 generates DC power from the plurality of photovoltaic panels as is well known to those of ordinary skill in the art. In one implementation, the two array subsections (array 1 and array 2) may be disposed in a bipolar topology (e.g., with all, or portions of, the first array subsection 106 being disposed below ground potential), but this is not required, and in other embodiments both of the array subsections 106 and 108 are disposed above or below ground potential. Each of the strings in each array subsection may be realized by a collection of any of a variety of different types of panels. In many embodiments, the power conversion component 102 is realized by an inverter that operates to convert the DC power from the photovoltaic array to AC power that is applied to an AC grid. But in other embodiments, the power conversion component 102 is a DC-to-DC conversion component, and in yet other embodiments the output of the pre-regulator 104 may be fed to a DC distribution system.

The pre-regulator 104 generally operates to provide a more consistent level of voltage to the power conversion component 102. More specifically, the exemplary pre-regulator 104 controls an arrangement of the array subsections 106 and 108 (array 1 and array 2) relative to one another to provide a more consistent and desirable application of voltage to the power conversion component 102. At one operational extreme for example, the array subsections 106 and 108 are simply paralleled (placed in parallel). In the other extreme, the array subsections 106 and 108 are placed in series. As discussed further herein, the pre-regulator 104 may also effectuate all array positions between pure parallel and pure series connections. Additionally, the power conversion component 102 may operate at a much higher voltage than it normally would without the pre-regulator 104 in place allowing a much greater application of power at a lower cost.

Referring next to FIG. 2, shown is an exemplary pre-regulator 204 that may be used to realize the pre-regulator 104 depicted in FIG. 1. As shown, the pre-regulator 204 in this embodiment regulates an application of variable DC voltage from a photovoltaic array 110 (including subsections 106 and 108) to a power conversion component (e.g., an inverter).

The pre-regulator 204 in this embodiment includes a first input 207 and a second input 209 to couple to the first array subsection 106 of the photovoltaic array 110; a third input 211 and a fourth input 213 to couple to the second array subsection 108 of the photovoltaic array 110; a first output terminal 214 and a second output terminal 216 to couple to a power conversion component; and a switch component 218 that switches the first pair of inputs (including the first input 207 and the second input 209) and the second pair of inputs (including the third input 211 and the fourth input 213) between a series arrangement and a parallel arrangement to regulate a voltage level of the power that is applied by both of the two array subsections 106 and 108 to the output pair of terminals 214, 216.

As shown, the first input 207 is coupled to a top node 230 of the switching component 218 (via an optional inductor) and the second input 209 is coupled to the first output terminal 214. The third input 211 is coupled to a bottom node 232 of the switching component 218 (via an optional inductor) and the fourth input 213 is coupled to the second output terminal 216, and a capacitor C1 is disposed between the first input 207 and the third input 211. The depicted optional inductors and the capacitor in this embodiment operate as a filter that reduces the likelihood that any noise from the switch 218 will be “seen” at the array subsections 106 and 108.

In addition, a first diode 234 is positioned between the first output 214 and the bottom node 232 with a cathode of the diode 234 coupled to the bottom node 232 and an anode of the diode 234 coupled to the first output 214. And a second diode 236 is positioned between the second output 216 and the top node 230 with an anode of the diode 236 coupled to the top node 230 and a cathode of the diode 236 coupled to the second output 216. A control component 220, which may be implemented by hardware, hardware in connection with software, hardware in connection with firmware, or combinations thereof, functions to enable the pre-regulator 204 to operate according to the methodologies described herein. More specifically, the control component 220 is coupled via a drive signal over a conductor (not shown) to the switching component 218 (e.g., to a gate of the switching component), and the control component 220 may modulate a duty cycle of the switching component 218 to change a percent of time the two array subsections 106 and 108 are arranged in series and in parallel.

At one operational extreme, where the switch component 218 (e.g., IGBT, MOSFET, or other electrically-controllable switch) is open, the array subsections 106 and 108 (array 1 and array 2) are simply paralleled (i.e., placed in parallel). In the other extreme, where the switch component 218 is persistently closed, the array subsections 106 and 108 are placed in series. This pre-regulator 204 can also manifest, by varying the duty cycle of the switch component 218, all array positions between pure parallel and pure series connections. In many modes of operation for example, by default, the array subsections 106 and 108 are arranged in parallel, and as as the percent of time the switching component 218 is closed increases, the percent of time the array subsections 106 and 108 are arranged in series increases. Beneficially, the switch component 218 and diodes 234 and 236 in this arrangement are substantially less stressed than in conventional buck or boost arrangements.

Beneficially, the depicted pre-regulator 204 enables a utility class inverter that would ordinarily operate to convert 1000 VDC from a photovoltaic array to 420 VAC to operate to convert the 1000 VDC to 600 VAC. More specifically, a 500 kW inverter that would ordinarily operate at 700 amps and 420 VAC, may operate to provide 600 VAC at 600 kW while operating under 600 amps. In other words, power may be increased by 20%, current may be reduced by 20%, and the voltage may be increased by 20%.

Referring next to FIG. 3, shown is another embodiment of a pre-regulator 304 utilizing two switch components 318A, 318B that may be utilized to realize the pre-regulator 104 shown in FIG. 1. By way of example, when operating at a 50% duty cycle, in the depicted interleaved embodiment, assuming operation occurs at 10 kHz cycles (100 microsecond period), a first switch component 318A may be on for 50 microseconds (and a second switch component 318B would be off), then the second switch component 318B would be on for 50 microseconds and the first switch component 318A would be off, so the period of each of the switch components 318A, 318B would be 200 microseconds (only switching at 5 kHz), and the operation of the switch components 318A, 318B is interleaved. So, when a maximum voltage is desired from the photovoltaic array 110, both switch components 318A, 318B may be on 100% of the time to place the array subsections 106, 108 in series. It should be recognized that the pre-regulator embodiments 104, 204, 304 in FIGS. 1, 2, and 3 are very different than conventional converters (e.g., conventional buck or boost converters). For example, with a conventional converter, the switch(es) cannot be closed all the time because there would be a dead short, but in this implementation, the switch components 218, 318A, 318B can be on 100% of the time.

Referring next to FIG. 4, it is a flowchart depicting an exemplary method for regulating an application of power in connection with the embodiments described with reference to FIGS. 1-3. As shown, at least a portion of a photovoltaic array is sectioned into two array sections (Block 402), and power is applied from the two array sections to a power conversion component (e.g., an inverter) (Block 404). A voltage that is applied by each of the two array subsections varies with environmental conditions affecting the two array sections. As depicted, a connection between the two array subsections is alternated between a series arrangement and a parallel arrangement to regulate a voltage level of the power that is applied by both of the two sections to the inverter (Block 406). In variations, the alternation between the series arrangement and the parallel arrangement is controlled to maximize power that is applied by the inverter.

Referring to FIGS. 5, 6, and 7 shown are respective graphical representations of the relative voltages of the array subsections 106 and 108 when the array subsections are arranged in parallel during an open-circuit mode; when the array subsections are arranged in a mixed-mode (between parallel and series) during low-power operation; and when the array subsections are arranged almost completely in series during a high-power mode of operation. It should be recognized that the depicted rail voltages (from +450 Volts to −450 volts) are exemplary voltages that may be utilized by a bipolar array where the array subsections may be positioned above and below ground potential, but in unipolar architectures (where both array subsections are disposed either above or below ground potential) the relative positioning of the arrays will be similar and there will be a voltage offset as compared to the voltages depicted in FIGS. 5, 6, and 7 (e.g., one rail may be 900 Volts and the other rail may be grounded).

In the open-circuit state depicted in FIG. 5, the switches (switch 218 in the embodiment depicted in FIG. 2 or switches 318A and 318B in the embodiment depicted in FIG. 3) are open. As depicted, each of the array subsections in this state may have an open circuit voltage that is 850 Volts, but neither of the array subsections spans the rail-to-rail voltage (from +450 Volts to −450 volts) that may be set and maintained by the power conversion component (e.g., the inverter). Thus, absent power being applied to close the switches 218 or 318A and 318B, the array subsections beneficially revert to a parallel arrangement where neither array subsection reaches the rail voltages and there is no current flow.

As depicted in FIG. 6, when the switch(es) 218 or 318A and 318B are engaged at a relatively low duty cycle, each of the subsections reaches the rail voltage and there may be a relatively large overlap of the voltages of each array subsection. FIG. 7 depicts the switch(es) 218 or 318A and 318B engaged at a relatively high duty cycle and the array subsections are almost completely arranged in series.

On extremely hot days, when the voltages output from the photovoltaic panels is low, the arrays can be placed closer to a series arrangement so that the series combination of the subsections adds to a desired voltage, and on colder days when the output voltages are high, the series combination of the array subsections may exceed an allowable voltage; thus the switch (218 in FIG. 2) or switches (318A and 318B in FIG. 3) may be switched at a relatively low duty cycle to effectively place the arrays close to parallel at a desired voltage.

Referring next to FIG. 8, shown is a block diagram depicting an exemplary control component that may be utilized to implement the control components 220 and 320 described with reference to FIGS. 2 and 3, respectively. As shown, in this embodiment the control component 820 includes a duty regulator 822 that is coupled to a drive signal generator 824 and an interface 826. The duty regulator 822 generally operates to produce switch-control signals 823 that are timed to effectuate the desired switching action of the switch components 218 and 318A, 318B in response to a control input 821. The drive signal generator 824 in this embodiment operates to convert the switch-control signals 823 into one or more drive signals 825 that are applied to the switch components 218 and 318A, 318B. For example, the switch-control signals 823 from the duty regulator 822 may be amplified by the drive signal generator 824 to generate voltages at a level sufficient to actuate the switch components 218 and 318A, 318B.

The depicted interface 826 may be realized by a man-machine interface such as a touch screen display and/or a machine-machine interface to enable configurable aspects of the control component 820 to be adjusted and to obtain operational information (e.g., status information) from the control component 820.

The control input 825 may be a measured parameter such as voltage and/or current that is applied to the power conversion component 102. Alternatively, the control input 825 may be a signal from a maximum power point tracking (MPPT) device that is utilized by the duty regulator 822 to regulate the duty cycle of the switch components 218 and 318A, 318B in order to effectuate a maximum application of power from the photovoltaic array 110. It is contemplated that the control input 825 may be generated by an MPPT component within the power conversion component 102 (e.g., with an inverter), or alternatively, MPPT-related sensors and logic may be implemented with the control component 820, which obviates the need for a MPPT device within the power conversion component 102.

Referring next to FIG. 9, shown is a block diagram depicting physical components of an exemplary computing device 900 that may be utilized to realize the control components 220, 320, 820 described herein. As shown, the computing device 900 in this embodiment includes a display portion 912, and nonvolatile memory 920 that are coupled to a bus 922 that is also coupled to random access memory (“RAM”) 924, a processing portion (which includes N processing components) 926, and a transceiver component 928 that includes N transceivers. Although the components depicted in FIG. 9 represent physical components, FIG. 9 is not intended to be a hardware diagram; thus many of the components depicted in FIG. 9 may be realized by common constructs or distributed among additional physical components. Moreover, it is certainly contemplated that other existing and yet-to-be developed physical components and architectures may be utilized to implement the functional components described with reference to FIG. 9.

This display portion 912 generally operates to provide a user interface for a user, and in several implementations, the display is realized by a touchscreen display. In general, the nonvolatile memory 920 functions to store (e.g., persistently store) data and executable code including code that is associated with the control components 220, 320, 820, and in particular, the duty regulator 822. In some embodiments for example, the nonvolatile memory 920 includes bootloader code, operating system code, file system code, and non-transitory processor-executable code to facilitate the implementation of one or more portions of the duty regulator 822.

In many implementations, the nonvolatile memory 920 is realized by flash memory (e.g., NAND or ONENAND memory), but it is certainly contemplated that other memory types may be utilized as well. Although it may be possible to execute the code from the nonvolatile memory 920, the executable code in the nonvolatile memory 920 is typically loaded into RAM 924 and executed by one or more of the N processing components in the processing portion 926.

The N processing components in connection with RAM 924 generally operate to execute the instructions stored in nonvolatile memory 920 to effectuate the functional protection, diagnostics, and/or optimization components. For example, non-transitory processor-executable instructions to effectuate one or mores aspects of the methods described herein may be persistently stored in nonvolatile memory 920 and executed by the N processing components in connection with RAM 924. As one of ordinarily skill in the art will appreciate, the processing portion 926 may include a video processor, digital signal processor (DSP), graphics processing unit (GPU), and other processing components.

The input component operates to receive analog and/or digital signals that may include voltage, current, and/or the control input 821 described with reference to FIG. 8. The output component provides signals (e.g., analog voltages) that may be utilized to open and close the N switch components 218, 318A, 318B.

The depicted transceiver component 928 includes N transceiver chains, which may be used for communicating with external devices via wireless or wireline networks. Each of the N transceiver chains may represent a transceiver associated with a particular communication scheme.

Although FIG. 9 depicts components that may be utilized to implement the control component 220, 320, 820, those of skill will appreciate that the various illustrative logical blocks, modules, circuits, and algorithm steps described in connection with the embodiments disclosed herein may be implemented an application specific integrated circuit (ASIC), a field programmable gate array (FPGA) or other programmable logic device, discrete gate or transistor logic, discrete hardware components, or any combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for regulating an application of power from a photovoltaic array, the method comprising:
sectioning at least a portion of the photovoltaic array into two array subsections;
applying power from the two array subsections to a power conversion component, a voltage that is applied by each of the two subsections varies with environmental conditions affecting the two array sections; and
alternating a connection between the two array subsections from a series arrangement and a parallel arrangement to regulate a voltage level of the power that is applied by both of the two subsections to the power conversion component.

2. The method of claim 1, including:
controlling the alternating to maximize power that is applied by the power conversion component.

3. The method of claim 2 including:
receiving a control input from a maximum power point tracking component; and
utilizing the control input to control the alternating to maximize the power that is applied by the power conversion component.

4. The method of claim 1, including:
converting the power that is applied by both of the two subsections to AC power with the power conversion component.

5. A system for regulating an application of power from a photovoltaic array, the system comprising:
means for sectioning at least a portion of the photovoltaic array into two array subsections;
means for applying power from the two array subsections to a power conversion component, a voltage that is applied by each of the two subsections varies with environmental conditions affecting the two array sections; and
means for alternating a connection between the two array subsections from a series arrangement and a parallel arrangement to regulate a voltage level of the power that is applied by both of the two subsections to the power conversion component.

6. The system of claim 5, including:
means for controlling the means for alternating to maximize power that is applied by the power conversion component.

7. The system of claim 6 including:
means for receiving a control input from a maximum power point tracking component; and
means for utilizing the control input to control the alternating to maximize the power that is applied by the power conversion component.

8. The system of claim 5, wherein the power conversion component is an inverter.

9. A pre-regulator for regulating an application of variable DC voltage, the pre-regulator including:
a first pair of inputs, including a first input and a second input, to couple to a first subsection of the photovoltaic array;
a second pair of inputs, including a third input and a fourth input, to couple to a second subsection of the photovoltaic array;
an output pair of terminals, including a first output terminal and a second output terminal, to couple to a power conversion device; and
a switching component that switches the first and second pair of inputs between a series arrangement and a parallel arrangement to regulate a voltage level of the power that is applied by both of the two subsections to the output pair of terminals.

10. The pre-regulator of claim 9, wherein the first input is coupled to a top node of the switching component and the second input is coupled to the first output terminal;
wherein the third input is coupled to a bottom node of the switching component and the fourth input is coupled to the second output terminal;
wherein an anode of a first diode is coupled to the first output, and a cathode of the first diode is coupled to the bottom node of the switching component; and
wherein a cathode of a second diode is coupled to the second output, and an anode of the second diode is coupled to the top node of the switching component.

11. The pre-regulator of claim 10, wherein a capacitor is disposed between the first input and the second input.

12. The pre-regulator of claim 10, wherein the first input is coupled to the top node of the switching component via a first inductor, and the third input is coupled to the bottom node of the switching component via a second inductor.

13. The pre-regulator of claim 9 including:
a control component coupled to the switching component, the control component including a control input to receive a control signal;
a non-transitory, tangible processor readable storage medium, encoded with processor executable instructions to perform a method, the method comprising:
applying power from the two array subsections to a power conversion component; and
modulating a duty cycle of the switching component to regulate the voltage level of the power that is applied by both of the two subsections to the power conversion component.

14. The pre-regulator of claim 13 wherein the non-transitory, tangible processor readable storage medium, includes instructions for modulating the duty cycle to maximize power that is output by the power conversion component.
